(19) United States
(12) Patent Application Publication
(10) Pub. No.: US 2014/0045011 A1
(43) Pub. Date: Feb. 13, 2014

(54) NON-AQUEOUS ELECTROLYTE SECONDARY BATTERY

(71) Applicant: Sanyo Electric Co., Ltd., Moriguchi City (JP)

(72) Inventors: Shinichi Yamami, Kasai City, Hyogo (JP); Toshikazu Yoshida, Kasai City, Hyogo (JP); Toyoki Fujihara, Kanzaki-gun, Hyogo (JP); Toshiyuki Nohma, Kobe City, Hyogo (JP)

(21) Appl. No.: 13/942,869

(22) Filed: Jul. 16, 2013

(30) Foreign Application Priority Data
Aug. 9, 2012 (JP) 2012-177185

(51) Int. Cl. H01M 10/0561

(52) U.S. Cl. CPC H01M 10/0561
USPC 429/94; 429/188; 429/199

(57) ABSTRACT

To provide with high productivity a non-aqueous electrolyte secondary battery having superior battery characteristics and a high capacity.

The present invention is a non-aqueous electrolyte secondary battery including a battery assembly having a negative electrode, a positive electrode and a separator, as well as a non-aqueous electrolyte. In this non-aqueous electrolyte secondary battery, the non-aqueous electrolyte includes lithium bis(oxalato)borate, the negative electrode has a negative electrode core and a negative electrode active material layer formed on the negative electrode core, the packing density of the negative electrode active material layer is from 1.1 g/ml to 1.38 g/ml, and the battery capacity of the non-aqueous electrolyte secondary battery is equal to or greater than 21 Ah.

### CROSS-REFERENCE TO RELATED APPLICATIONS

This application claims the benefit of Japanese Patent Application No. 2012-177185 filed Aug. 9, 2012, the disclosure of which is herein incorporated by reference in its entirety.

### FIELD OF THE INVENTION

The present invention relates to a non-aqueous electrolyte secondary battery and, more specifically, to an improvement in the battery characteristics of a non-aqueous electrolyte secondary battery.

### BACKGROUND

Battery-powered vehicles with a secondary battery power supply, such as electric vehicles (EV) and hybrid electric vehicles (HEV), are becoming increasingly popular. However, these battery-powered vehicles require high-output/high-capacity secondary batteries.

Non-aqueous electrolyte secondary batteries, such as lithium ion secondary batteries, have a high energy density and a high capacity. The positive electrode and negative electrode plates have an active material layer provided on both sides of the electrode core, and the positive electrode plate and negative electrode plate are wound together or laminated on each other via a separator to form an electrode assembly. This electrode assembly increases the opposing surface area between the positive and negative electrodes, and facilitates the extraction of a large current. As a result, non-aqueous electrolyte secondary batteries using a wound or laminated electrode assembly are used for this purpose.

In Patent Document 1, a technology related to a collector structure for stably extracting current from a high-output battery has been proposed.

### PRIOR ART DOCUMENTS

### Patent Document

Patent Document 1 Published Unexamined Patent Application No. 2010-086780

The technology disclosed in Patent Document 1 is a rectangular secondary battery in which a first current collecting plate is arranged in a first electrode core collecting area from which first electrode cores laminated directly on top of each other protrude. The first current collecting plate is resistance-welded on a surface parallel to the plane on which the first electrode cores are laminated. In this secondary battery, a first electrode core melt-attachment portion to which the first electrode cores are melt-attached is formed in an area separate from the area in which the first current collecting plate is attached.

### SUMMARY

### Problem Solved by the Invention

In addition to a better collector structure, vehicle-mounted batteries also require improved productivity and battery characteristics, such as output characteristics and cycle characteristics. However, these problems are not considered in Patent Document 1.

In view of this situation, an object of the present invention is to provide with high productivity a non-aqueous electrolyte secondary battery having superior battery characteristics and a high capacity.

### Means of Solving the Problem

In order to solve this problem, the present invention is a non-aqueous electrolyte secondary battery including a negative electrode and a non-aqueous electrolyte, in which the non-aqueous electrolyte includes lithium bis(oxalato)borate, the negative electrode has a negative electrode core and a negative electrode active material layer formed on the negative electrode core, the packing density of the negative electrode active material layer is from 1.1 g/ml to 1.38 g/ml, and the battery capacity is equal to or greater than 21 Ah.

Lithium bis(oxalato)borate is added to the non-aqueous electrolyte. This increases the input/output characteristics and cycle characteristics of the battery. However, when lithium bis(oxalato)borate is added to the non-aqueous electrolyte, the viscosity of the non-aqueous electrolyte increases, and the non-aqueous electrolyte penetrates into the negative electrode active material layer with difficulty. Because the size of the negative electrode active material layer is especially large in the case of a high-capacity battery with a battery capacity equal to or greater than 21 Ah, impregnation of the negative electrode active material layer with the non-aqueous electrolyte is reduced significantly.

Because the packing density of the negative electrode active material layer is 1.38 g/ml or less, the porosity of the negative electrode active material layer is increased, and impregnation of the negative electrode active material layer with lithium bis(oxalato)borate is improved. As a result, the input/output characteristics and cycle characteristics of a high-capacity battery can be improved. Because the time required to impregnate the negative electrode active material layer with non-aqueous electrolyte is also significantly reduced, battery productivity can be improved.

In order to increase energy density, the packing density of the negative electrode active material layer is 1.1 g/ml or greater.

Here, the battery capacity is the discharge capacity (initial capacity) when the battery has been charged to a battery voltage of 4.1 V using 21 A of constant current, charged for 1.5 hours at a constant voltage of 4.1 V, and then discharged after charging to a battery voltage of 2.5 V at a constant current of 21 A. The charging and discharging was performed entirely at 25° C.

The packing density of the negative electrode active material layer can be controlled, for example, by adjusting the pressure when the negative electrode active material layer is rolled.

This non-aqueous electrolyte secondary battery may be configured so that the non-aqueous electrolyte contains from 0.06 to 0.18 mol/L lithium bis(oxalato)borate. When the non-aqueous electrolyte contains less lithium bis(oxalato)borate, the effect is insufficient. When more lithium bis(oxalato)borate is added, the upper limit on effectiveness is exceeded and the additional amount is not cost effective.

This non-aqueous electrolyte secondary battery may be configured so that the non-aqueous electrolyte also contains lithium difluorophosphate (LiPO₂F₂). Because the lithium difluorophosphate is included in the non-aqueous electrolyte as an electrolyte salt, the low-temperature output characteristics of the battery are improved.

The amount of lithium difluorophosphate included in the non-aqueous electrolyte is preferably from 0.01 to 0.10 mol/L. When the non-aqueous electrolyte contains less lithium difluorophosphate, the effect is insufficient. When more lithium difluorophosphate is added, the upper limit on effectiveness is exceeded and the additional amount is not cost effective. Battery costs also rise when the concentration is too high.

The ranges for the amount of lithium bis(oxalato)borate and lithium difluorophosphate included in the non-aqueous electrolyte are determined based on the non-aqueous electrolyte in the non-aqueous electrolyte secondary battery after assembly and before the first charge. The ranges are determined in this manner because the amount gradually decreases as the non-aqueous electrolyte battery containing these compounds is charged.

This non-aqueous electrolyte secondary battery may be configured so that the negative electrode active material included in the negative electrode active material layer is a carbon material. This is because carbon materials have superior discharge characteristics.

The carbon material can be flaky graphite particles and coated graphite particles in which the surface of the graphite particles is coated by a coating layer including amorphous carbon particles and an amorphous carbon layer.

Amorphous carbon has a smaller capacity than graphite, but accepts lithium ions better and so lithium is less likely to precipitate on the surface. By using coated graphite particles, precipitation of lithium during rapid charging can be suppressed without sacrificing capacity, and this can improve the high-rate charge-discharge cycle characteristics.

By including flaky graphite particles which have a higher electron conductivity than coated graphite particles, any rise in internal resistance in the negative electrode can be suppressed. Also, by including amorphous carbon particles in the amorphous carbon layer of the coated graphite particles, the conductivity of the coating layer can be increased and any rise in internal resistance in the negative electrode can be further suppressed. Because the change in volume of flaky graphite particles due to charging and discharging is less than that of coated graphite particles, the flaky graphite particles act as a cushioning material that absorbs any volume change in the coated graphite particles, and this suppresses wrinkling that occurs over the charge/discharge cycle.

The graphite particles are both round and flaky. The flaky particles have a high specific surface area and readily form a good conductive path, while the round particles have a small specific surface area and thus have good packing qualities. Therefore, the graphite particles used along with the coated graphite particles are preferably flaky graphite particles, while the graphite particles forming the nucleus of the coated graphite particles are preferably round graphite particles.

Here, round graphite particle means a graphite particle with an aspect ratio (long axis/short axis) of 2.0 or less, and a flaky graphite particle means a graphite particle with an aspect ratio of 2.5 or more. The aspect ratio can be measured by magnifying the particles using a scanning electron microscope (with a magnification factor of, for example, 1000).

In this non-aqueous electrolyte secondary battery, the electrode assembly may be a wound electrode assembly in which the positive electrode, negative electrode and an interposed separator are wound together. In a wound electrode assembly, the non-aqueous electrolyte has poor permeability because it can only penetrate into the electrode assembly from the two ends perpendicular to the winding axis of the electrode assembly. However, the present invention is very effective when used in a battery with a wound electrode assembly.

### Effect of the Invention

The present invention is able to provide with high productivity a non-aqueous electrolyte secondary battery having superior battery characteristics and a high capacity.

### BRIEF DESCRIPTION OF THE DRAWINGS

FIG. 1 is a perspective view of a non-aqueous electrolyte secondary battery according to the present invention.

FIG. 2 is a diagram showing the electrode assembly used in a non-aqueous electrolyte secondary battery according to the present invention.

FIG. 3 is a plan view showing the positive and negative electrode plates used in a non-aqueous electrolyte secondary battery according to the present invention.

### DETAILED DESCRIPTION

### Embodiment 1

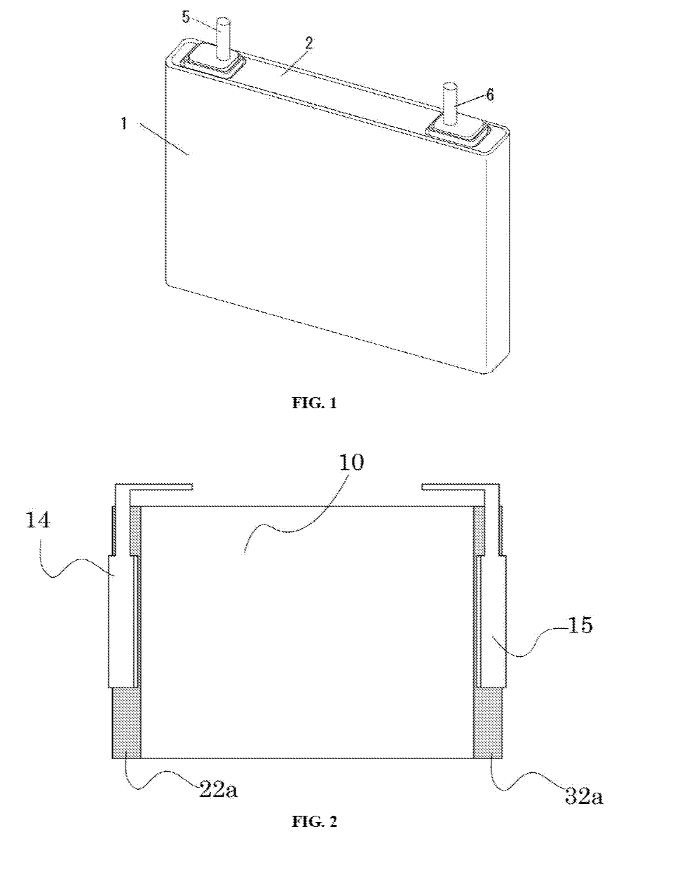

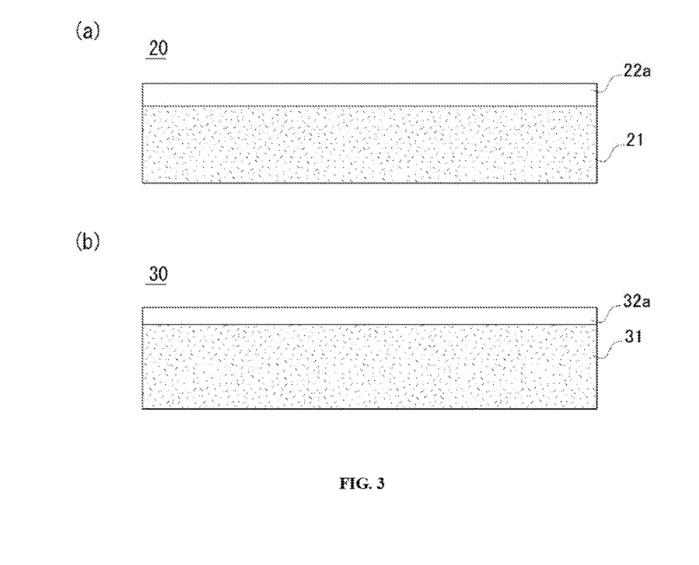

The following is an explanation with reference to the drawings of the battery of the present invention as applied to a lithium ion secondary battery. FIG. 1 is a perspective view of a lithium ion secondary battery according to the present invention, FIG. 2 is a diagram showing the electrode assembly used in the lithium ion secondary battery, and FIG. 3 is a plan view showing the positive and negative electrode plates used in the non-aqueous electrolyte secondary battery of the first embodiment.

As shown in FIG. 1, a lithium ion secondary battery of the present invention has a rectangular outer can 1 with an opening, a sealing component 2 for sealing the opening in the outer can 1, and positive and negative electrode terminals 5, 6 protruding outward from the sealing component 2.

Also, as shown in FIG. 3, the positive electrode plate 20 in the electrode assembly has a positive electrode core exposing portion 22a exposed on at least one end in the longitudinal direction of the band-shaped positive electrode core, and a positive electrode active material layer 21 formed on the positive electrode core. The negative electrode plate 30 has a first negative core exposing portion 32a exposed on at least one end in the longitudinal direction of the band-shaped negative electrode core, and a negative electrode active material layer 31 formed on the negative electrode core.

In the electrode assembly 10, the positive electrode and the negative electrode are wound together via an interposed separator which is a microporous polyethylene membrane. As shown in FIG. 2, the positive electrode core exposing portion 22a protrudes from one end of the electrode assembly 10, the negative electrode core exposing portion 32a protrudes from the other end of the electrode assembly 10, the positive electrode collector plate 14 is mounted on the positive electrode core exposing portion 22a, and the negative electrode collector plate 15 is mounted on the negative electrode core exposing portion 32a.

This electrode assembly 10 is housed inside the outer can 1 along with the non-aqueous electrolyte, and the positive electrode collector plate 14 and the negative electrode collector plate 15 are connected electrically to external electrodes 5, 6 protruding from the sealing component 2 while being insulated from the sealing component 2 to extract current.

The non-aqueous electrolyte includes a non-aqueous solvent and an electrolyte salt dissolved in the solvent. Lithium bis(oxalato)borate is then added to the non-aqueous electrolyte. By using a non-aqueous electrolyte containing lithium bis(oxalato)borate, the input/output characteristics and the cycle characteristics of the battery can be improved.

When lithium bis(oxalato)borate is added to the non-aqueous electrolyte, the viscosity of the non-aqueous electrolyte increases. In the present invention, the battery capacity equal to or greater than 21 Ah, and size of the negative electrode active material layer 31 in such a battery is especially large. Therefore, impregnation of the negative electrode active material layer 31 with the non-aqueous electrolyte is reduced significantly.

However, because the packing density of the negative electrode active material layer 31 is from 1.1 to 1.38 g/ml, the porosity of the negative electrode active material layer 31 is increased, and impregnation of the negative electrode active material layer with lithium bis(oxalato)borate is improved. As a result, the input/output characteristics and cycle characteristics of a high-capacity battery can be improved. Also, because the time required to impregnate the negative electrode active material layer 31 with non-aqueous electrolyte is also significantly reduced, battery productivity can be improved. The amount of lithium bis(oxalato)borate included is preferably from 0.06 to 0.18 mol/L.

In order to improve low-temperature output characteristics, lithium difluorophosphate may also be added to the non-aqueous electrolyte. The amount of lithium difluorophosphate included is preferably from 0.01 to 0.10 mol/L.

An embodiment of the present invention will now be explained with reference to examples. The present invention is not limited to the present embodiment, and may be modified where appropriate within the spirit and scope of the invention.

### EXAMPLES

### Example 1

In the following example, the non-aqueous electrolyte secondary battery shown in FIG. 1 through FIG. 3 was prepared.

### Preparation of Positive Electrode

A lithium-transition metal composite oxide (LiNi_{0.35}Co_{0.35}Mn_{0.3}O₂) serving as the positive electrode active material, carbon black serving as the conductive agent, and N-methylpyrrolidone (NMP) solution of polyvinylidene fluoride serving as the bonding agent were kneaded together to obtain a positive electrode active material slurry with a lithium-transition metal composite oxide:carbon black:polyvinylidene fluoride solid mass ratio of 91.5:5:3.5.

After applying the positive electrode active material slurry to both sides of aluminum alloy foil serving as the positive electrode core (thickness: 15 μm), the slurry was dried to remove the NMP used as the solvent in slurry preparation and to form positive electrode active material layers on the positive electrode core. This was then rolled using a mill roll and cut to predetermined dimensions to complete the positive electrode plate 20. A positive electrode core exposing portion 22a was provided in the positive electrode plate 20 to expose the core in the longitudinal direction of the positive electrode core for connection to the positive electrode collector plate.

### Preparation of Negative Electrode

Natural graphite fashioned into round graphite particles, pitch and carbon black were mixed together to coat the surface of the round graphite particles with pitch and carbon black. The mass ratio of round graphite particles to pitch to carbon black in the mixture was 100:5:5 at this time.

When the center particle size D50 of the round graphite particles and carbon black was measured using a laser diffraction-type particle size analyzer (Seishin Enterprise LMS-30), the D50 of the round graphite particles was 14 μm, and the D50 of the carbon black was 50 nm.

The resulting compound was baked for 24 hours at 1,500° C. in an inactive gas atmosphere, and the baked project was ground and pulverized to obtain coated graphite particles in which the surface of the graphite particles was coated with a coating layer of amorphous carbon particles and an amorphous carbon layer.

When the center particle size D50 of the coated graphite particles was measured using a laser diffraction-type particle size analyzer (Seishin Enterprise LMS-30), the D50 of the coated graphite particles was 14 μm.

A negative electrode active material slurry was prepared by kneading together the coated graphite particles, the flaky graphite, a carboxymethylcellulose (CMC) thickener, a styrene-butadiene rubber (SBR) bonding agent, and water. The mass ratio of the graphite particles, the CMC and the SBR at this time was 98.7:0.7:0.6. The mass of the flaky graphite was 4.0% of the combined mass of the coated graphite particles and flaky graphite.

After applying the negative electrode active material slurry to both sides of copper foil serving as the negative electrode core (thickness: 10 μm), the slurry was dried to remove the water used as the solvent in slurry preparation and to form negative electrode active material layers on the negative electrode core. This was then rolledusing a mill roll to obtain a predetermined packing density (1.28 g/ml), and cut to predetermined dimensions to complete the negative electrode plate 30. A negative electrode core exposing portion 32a was provided in the negative electrode plate 30 to expose the core in the longitudinal direction of the negative electrode core for connection to the negative electrode collector plate.

When the center particle size D50 of the flaky graphite particles was measured using a laser diffraction device (MicroTrak 9220-FRA), the D50 of the flaky graphite particles was 7 μm.

The packing density of the negative electrode active material layer was determined in the following manner. First, the negative electrode plate was cut to 10 cm², and the mass A (g) of the cut 10 cm² negative electrode plate and the thickness C (cm) of the negative electrode plate were measured. Next, the mass B (g) of the 10 cm² core and the thickness D (cm) of the core were measured. Finally, the packing density was determined using the following equation:

Packing Density=(A−B)/[(C−D)×10 cm²]

### Preparation of Electrode Assembly

The positive electrode plate, the negative electrode plate and a polyethylene microporous membrane separator (thickness: 30 μm) were laid on top of each other so that the positive electrode core exposing portion 22a and the negative electrode core exposing portion 32a protruded from the three layers in opposite directions relative to the winding direction, and so that the separator was interposed between the different active material layers. The layers were then wound together using a winding machine, insulated tape was applied to prevent unwinding, and the resulting electrode assembly was flattened using a press.

### Connecting the Collector Plates to the Sealing Component

An aluminum positive electrode collector plate 14 and a copper negative electrode collector plate 15 with two protrusions (not shown) on the same surface were prepared, and two aluminum positive electrode collector plate receiving components (not shown) and two copper negative electrode collector plate receiving components (not shown) with one protrusion on one surface were also prepared. Insulating tape was applied to enclose the protrusions of the positive electrode collector plate 14, negative electrode collector plate 15, positive electrode collector plate receiving components and negative electrode collector plate receiving components.

A gasket (not shown) was arranged on the inside surface of a through-hole (not shown) provided in the sealing component 2, and on the outside surface of the battery surrounding the through-hole, and an insulating component (not shown) was arranged on the inside surface of the battery surrounding the through-hole provided in the sealing component 2. The positive electrode collector plate 14 was positioned on top of the insulating component on the inside surface of the sealing component 2 so that the through-hole in the sealing component 2 was aligned with the through-hole (not shown) in the collector plate. Afterwards, the inserted portion of a negative electrode terminal 5 having a flange portion (not shown) and an inserted portion (not shown) was inserted from outside the battery into the through-hole in the sealing component 2 and the through-hole of the collector plate. The diameter of the lower end of the inserted portion (inside the battery) is then widened, and the positive electrode collector plate 14 and the positive electrode terminal 5 were caulked to the sealing component 2.

The negative electrode collector plate 15 and the negative electrode terminal 6 were caulked to the sealing component 2 in the same way on the negative electrode side. In this operation, the various components were integrated, and the positive and negative electrode collector plates 14, 15 and the positive and negative electrode terminals 5, 6 were connected conductively. In this structure, the positive and negative electrode terminals 5, 6 protruded from the sealing component 2 while remaining insulated from the sealing component 2.

### Mounting of Collector Plate

The positive electrode collector plate 14 was arranged on the side of the flat electrode assembly with the core exposing portion of the positive electrode 11 so that the protrusion was on the side with the positive electrode core exposing portion 22a. One of the positive electrode collector plate receiving components is brought into contact with the positive electrode core exposing portion 22a so that the protrusion on the positive electrode collector plate receiving component is on the positive electrode core exposing portion 22a side, and so that one of the protrusions on the positive electrode collector plate 14 is facing the protrusion on the positive electrode collector plate receiving component. Next, a pair of welding electrodes is pressed against the back of the protrusion on the positive electrode collector plate 14 and on the back of the positive electrode collector plate receiving component, current flows through the pair of welding electrodes, and the positive electrode collector plate 14 and the positive electrode collector plate receiving component are resistance-welded to the positive electrode core exposing portion 22a.

Afterwards, the other positive electrode collector plate receiving portion is brought into contact with the positive electrode core exposing portion 22a so that the protrusion on the positive electrode collector plate receiving portion is on the positive electrode core exposing portion 22a side, and so that the other protrusion on the positive electrode collector plate 14 is facing the protrusion on the positive electrode collector plate receiving component. Next, the pair of welding electrodes is pressed against the back of the protrusion on the positive electrode collector plate 14 and on the back of the positive electrode collector plate receiving component, current flows through the pair of welding electrodes, and the positive electrode collector plate 14 and the positive electrode collector plate receiving component are resistance-welded a second time to the positive electrode core exposing portion 22a.

In the case of the negative electrode plate 30, the negative electrode collector plate 15 and the negative electrode collector plate receiving components are resistance-welded to the first negative electrode core exposing portion 32a in the same way.

### Preparation of Non-Aqueous Electrolyte

Ethylene carbonate, which is a cyclic carbonate, and ethylene methyl carbonate, which is a linear carbonate, were mixed together at a volume ratio of 3:7 (1 atm, 25° C.), and a lithium hexafluorophosphate (LiPF₆) electrolyte salt was dissolved in the resulting mixed solvent at a ratio of 1 mol/L. To the resulting solution were added vinylene carbonate at a concentration of 0.3 mass %, lithium bis(oxalato)borate at a concentration of 0.12 mol/L, and lithium difluorophosphate at a concentration of 0.05 mol/L to complete the non-aqueous electrolyte.

### Assembly of Battery

The electrode assembly 10 integrated with the sealing component 2 was inserted into the outer can 1, the sealing component 2 was fitted into the opening in the outer can 1, the welded portion of the outer can 1 was laser-welded around the sealing component 2, a predetermined amount of non-aqueous electrolyte was poured in via a non-aqueous electrolyte hole (not shown) in the sealing component 2, the non-aqueous electrolyte hole was sealed, and the non-aqueous electrolyte secondary battery in the first example was complete.

### Example 2

The non-aqueous electrolyte secondary battery in the second example was prepared in the same manner as the first example, except that the pressure was adjusted when the negative electrode active material layer was rolled to obtain a negative electrode active material layer packing density of 1.38 g/ml.

### Measurement of Battery Capacity

The battery capacities of the batteries in the first example and the second example were measured in the following manner. The batteries were charged at a constant current of 21 A to a battery voltage of 4.1 V, and then charged for 1.5 hours at a constant current of 4.1 V. After charging, the batteries were discharged at a constant current of 21 A to a battery voltage of 2.5 V. The discharge capacity at this time was the battery capacity. As a result, the battery capacity of the battery in the first example was 24.7 Ah, and the battery capacity of the battery in the second example was 25.3 Ah.

### Evaluation

### Room Temperature IV Measurement (Output)

The batteries in the first and second examples were charged at 25° C. and at a constant current of 21 A to a state of charge (SOC) of 50%. Afterwards, the batteries were discharged for ten seconds each at constant currents of 1.6 C, 3.2 C, 4.8 C, 6.4 C, 8.0 C and 9.6 C. The battery voltages were measured, each current value and battery voltage was plotted, and the room temperature output voltage was determined (voltage W during a 3 V discharge). The results are shown in Table 1.

### Room Temperature IV Measurement (Regeneration)

The batteries in the first and second examples were charged at 25° C. and at a constant current of 21 A to a state of charge (SOC) of 50%. Afterwards, the batteries were charged for ten seconds each at constant currents of 1.6 C, 3.2 C, 4.8 C, 6.4 C, 8.0 C and 9.6 C. The battery voltages were measured, each current value and battery voltage was plotted, and the room temperature output regeneration was determined (voltage W during a 4.3 V charge). The results are shown in Table 1.

### Low Temperature IV Measurement (Output)

The batteries in the first and second examples were charged at 25° C. and at a constant current of 21 A to a state of charge (SOC) of 50%. Afterwards, the batteries were discharged at −30° C. for ten seconds each at constant currents of 0.8 C, 1.6 C, 2.4 C, 3.2 C, 4.0 C, 4.8 C, 5.6 C and 6.4 C. The battery voltages were measured, each current value and battery voltage was plotted, and the room temperature output regeneration was determined (voltage W during a 3 V discharge). The results are shown in Table 1.

### Low Temperature IV Measurement (Regeneration)

The batteries in the first and second examples were charged at 25° C. and at a constant current of 21 A to a state of charge (SOC) of 50%. Afterwards, the batteries were charged at −30° C. for ten seconds each at constant currents of 0.6 C, 0.8 C, 1.0 C, 1.2 C, 1.4 C, 1.6 C and 1.8 C. The battery voltages were measured, each current value and battery voltage was plotted, and the room temperature output regeneration was determined (voltage W during a 4.3 V charge). The results are shown in Table 1.

TABLE 1

| | Packing Density | | | | |
|---|---|---|---|---|---|
| | of Negative | Room | Room | Low | Low |
| | Electrode Active | Temperature | Temperature | Temperature | Temperature |
| | Material Layer | Output | Regeneration | Output | Regeneration |
| | (g/ml) | (W) | (W) | (W) | (W) |
| Example 1 | 1.28 | 1184 | 1629 | 368 | 213 |
| Example 2 | 1.38 | 1126 | 1536 | 360 | 205 |

It is clear from Table 1 that the battery in the first example, which included lithium bis(oxalato)borate in the non-aqueous electrolyte and which had a negative electrode active material layer packing density of 1.28 g/ml, and the battery in the second example, which included lithium bis(oxalato)borate in the non-aqueous electrolyte and which had a negative electrode active material layer packing density of 1.38 g/ml, had room temperature output values greater than 1,000 W, which are sufficiently high values. The room temperature regeneration values were greater than 1,300 W, which are also sufficiently high values.

The low temperature output values for the batteries in the first and second examples were 368 W and 360 W, respectively, and the low temperature regeneration values were 213 W and 205 W. The low temperature output values and low temperature regeneration values were lower than the room temperature output values and room temperature regeneration values, but were found to allow for charging and discharging at a current value from 50 to 120 A, even in low temperature environments.

In the battery of the first example, which had the lower negative electrode active material layer packing density, the room temperature and low temperature input values and regeneration values were slightly better. It is believed this is because a lack of non-aqueous electrolyte is less likely to occur in the battery of the first example, even when charging and discharging at high rate.

### Additional Details

The mass ratio of flaky graphite particles in the negative electrode active material is preferably from 1 to 6 wt %. When the amount of flaky graphite particles is lower, the conductivity improving effect and the volume expansion buffering effect are reduced. When the amount of flaky graphite particles is greater, lithium is more likely to precipitate on the surface of the flaky graphite particles.

When expressed as 100:α:β, the mass ratio of graphite particles to amorphous carbon particles to amorphous carbon layer in the coated graphite particles preferably satisfies 1≦α≦10, 1≦β≦10, α≦1.34 β. When the mass of both the amorphous carbon particles and amorphous carbon layer are greater than 10% of the mass of the graphite particles forming the nucleus, the discharge capacity may be reduced. When the mass of the amorphous carbon particles is too low, a sufficient charge improving effect is difficult to achieve. When the mass of the amorphous carbon layer is too low, the amorphous carbon particles tend to come off the graphite particles.

The center particle size of the coated graphite particles as measured by laser diffraction is preferably from 12 to 16 μm. When the center particle size of the coated graphite particles is smaller, the application properties of the slurry tend to be poorer when the negative electrode is created. When the center particle size of the coated graphite particles is greater, the points of contact between the materials are fewer and the conductive properties of the negative electrode tend to be poorer.

The center particle size of the flaky graphite particles as measured by laser diffraction is preferably from 5 to 10 μm. When the center particle size of the flaky graphite particles is smaller, the application properties of the slurry tend to be poorer when the negative electrode is created. When the center particle size of the flaky graphite particles is greater, the conductive paths created by the flaky graphite particles are crude and the conductive properties of the negative electrode tend to be poorer.

The positive electrode active material can be one or more of the following: a lithium-containing nickel-cobalt-manganese composite oxide (LiNiₓCo_{y}Mn_{z}O₂, x+y+z=1, 0≦x≦1, 0≦y≦1, 0≦z≦1), a lithium-containing cobalt composite oxide (LiCoO₂), lithium-containing nickel composite oxide (LiNiO₂), a lithium-containing nickel-cobalt composite oxide (LiCoₓNi₁₋ₓO₂), a lithium-containing manganese composite oxide (LiMnO₂), spinel-type lithium manganese oxide (LiMn₂O₄), or a lithium-containing transition metal composite oxide in which some of the transition metal in the oxide has been substituted by another element (for example, Ti, Zr, Mg, Al, etc.).

In addition to lithium bis(oxalato)borate and lithium difluorophosphate, one or more other lithium salts (base electrolyte salts) can be used as electrolyte salts. Examples include LiPF₆, LiBF₄, LiCF₃SO₃, LiN(CF₃SO₂)₂, LiN(C₂F₅SO₂)₂, LiN(CF₃SO₂)(C₄F₉SO₂), LiC(C₂F₅SO₂)₃, LiAsF₆, LiClO₄, Li₂B₁₀Cl₁₀, Li₂B₁₂l₁₂, LiB(C₂O₄)F₂, and LiP(C₂O₄)₂F₂. The total concentration of electrolyte salts in the non-aqueous electrolyte is preferably from 0.5 to 2.0 mol/L.

The non-aqueous solvent can be one or more of the following: a high dielectric constant solvent in which lithium salts are highly soluble including a cyclic carbonate, such as ethylene carbonate, propylene carbonate, butylene carbonate or fluoroethylene carbonate, or a lactone such as γ-butyrolactone or γ-valerolactone; a linear carbonate, such as diethyl carbonate, dimethyl carbonate or ethyl methyl carbonate; or a low viscosity solvent including an ether, such as tetrahydrofuran, 1,2-dimethoxyethane, diethylene glycol dimethylethane, 1,3-dioxolane, 2-methoxytetrahydro furan or diethyl ether; or a carboxylic acid ester, such as ethyl acetate, propyl acetate or ethyl propionate. A mixed solvent including two or more types of high dielectric constant solvent and low viscosity solvent can also be used.

Any well-known additive, such as vinylene carbonate, cyclohexyl benzene, and tert-amyl benzene can be added to the non-aqueous electrolyte.

A microporous membrane or membrane laminate of an olefin resin, such as polyethylene, polypropylene or a mixture thereof, can be used as the separator.

### INDUSTRIAL APPLICABILITY

As explained above, the present invention can provide with high productivity a non-aqueous electrolyte secondary battery having a high capacity and excellent battery properties, such as output and regeneration properties. Thus, industrial applicability is great.

### KEY TO THE DRAWINGS

1: Outer Can
2: Sealing Component
5, 6: Electrode Terminals
10: Electrode Assembly
14: Positive Electrode Collector Plate
15: Negative Electrode Collector Plate
20: Positive Electrode Plate
21: Positive Electrode Active Material Layer
22a: Positive Electrode Core Exposing Portion
30: Negative Electrode Plate
31: Negative Electrode Active Material Layer
32a: Negative Electrode Core Exposing Portion

What is claimed is:

1. A non-aqueous electrolyte secondary battery including a battery assembly having a negative electrode, a positive electrode and a separator, as well as a non-aqueous electrolyte, the non-aqueous electrolyte secondary battery characterized in that the non-aqueous electrolyte includes lithium bis(oxalato)borate, the negative electrode has a negative electrode core and a negative electrode active material layer formed on the negative electrode core, the packing density of the negative electrode active material layer is from 1.1 g/ml to 1.38 g/ml, and the battery capacity of the non-aqueous electrolyte secondary battery is equal to or greater than 21 Ah.

2. The non-aqueous electrolyte secondary battery according to claim 1, wherein the concentration of lithium bis(oxalato)borate is from 0.06 to 0.18 mol/L.

3. The non-aqueous electrolyte secondary battery according to claim 1, wherein the negative electrode active material included in the negative electrode active material layer is a carbon material.

4. The non-aqueous electrolyte secondary battery according to claim 3, wherein the carbon material is flaky graphite particles and coated graphite particles, the surface of the graphite particles being coated by a coating layer including amorphous carbon particles and an amorphous carbon layer.

5. The non-aqueous electrolyte secondary battery according to claim 1, wherein the non-aqueous electrolyte also includes lithium difluorophosphate.

6. The non-aqueous electrolyte secondary battery according to claim 1, wherein the electrode assembly is a wound electrode assembly, the positive electrode and negative electrode and an interposed separator being wound together.
